(19) United States
(12) Patent Application Publication
(10) Pub. No.: US 2024/0423223 A1
(43) Pub. Date: Dec. 26, 2024

(54) STUNNING SYSTEM AND METHOD FOR STUNNING AN ANIMAL TO BE SLAUGHTERED IN AN ANIMAL-FRIENDLY AND INEXPENSIVE MANNER

(71) Applicant: BERND-TONNIES-STIFTUNG C/O GOKE & PARTNER, Bielefeld (DE)

(72) Inventor: Robert TÖNNIES, Bielefeld (DE)

(73) Assignee: BERND-TONNIES-STIFTUNG C/O GOKE & PARTNER, Bielefeld (DE)

(21) Appl. No.: 18/684,094

(22) PCT Filed: Sep. 2, 2022
(86) PCT No.: PCT/EP2022/074423

§ 371 Date: Feb. 15, 2024

(30) Foreign Application Priority Data
Sep. 6, 2021 (DE) 10 2021 122 996.0

(51) Int. Cl. A22B 3/00; A22B 7/00

(52) U.S. Cl. CPC A22B 3/005; A22B 7/001

(57) ABSTRACT

The invention relates to a stunning facility (10) for two-stage stunning a slaughter animal (12) by means of a pre-stunning gas (14) and a final stunning gas (16), comprising a stunning channel (18) comprising an entrance opening (20) and an exit opening (22) for providing a gas atmosphere which stuns the slaughter animal (12), a conveying device (46) passing through the stunning channel (18) for conveying the slaughter animal (12) through the stunning channel (18) in a transport direction (48) from the entrance opening (20) to the exit opening (22), a pre-stunning gas supply (28) for supplying the pre-stunning gas (14) into the stunning channel (18), a final stunning gas supply (32) for supplying the final stunning gas (16) into the stunning channel (18), a gas discharge (36) disposed in the transport direction (48) between the pre-stunning gas supply (28) and the final stunning gas supply (32) for discharging the gas atmosphere from the stunning channel (18), and a recovery system (44) connected to the gas discharge (36) for the pre-stunning gas (14) and/or the final stunning gas (16). The invention further relates to a method for stunning a slaughter animal (12) by use of the above stunning facility (10).

### DESCRIPTION

The invention relates to a stunning facility for two-stage stunning of a slaughter animal by means of a pre-stunning gas and a final stunning gas, comprising a stunning channel having an entrance opening and an exit opening for providing a gas atmosphere for stunning the slaughter animal.

The invention also relates to a method for stunning a slaughter animal, in particular by means of the above stunning system.

From EP 2617288 B1 a method and a facility for stunning a slaughter animal, in particular a pig, is known, wherein the slaughter animal is conveyed through a first environment containing a first gas and is pre-stunned and then conveyed through a second environment containing a second gas for stunning, wherein the first gas has a density differing from that of the second gas and from air. In order to enable pre-stunning and final stunning of the slaughter animal in a manner appropriate to the species, it is proposed by EP 2617288 B1 that the slaughter animal is driven into a receptacle designed as a gondola, that the receptacle with the slaughter animal is conveyed first upwards and then downwards through the first environment and then through the second environment, wherein a gas of lower density than air is used as the first gas and a gas of higher density than air is used as the second gas.

In order to ensure that only a small amount of the respective gas is discharged due to turbulences caused by the gondola in the first environment and the second environment, the two environments are positioned partially overlapping one above the other in the vertical direction, as a result of which the facility is designed to be large-volume and expensive with a great height.

WO 98/31 231 A1 describes a method and facility for the treatment, such as stunning or killing, of poultry by use of gas. The gas comprises oxygen and carbon dioxide among other components. In the facility, the poultry is exposed to the gas in a chamber which may comprise a belt conveyor, wherein the chamber is further divided into three treatment zones.

DE 697 15 459 T2 relates to an improved method and apparatus for anesthetizing animals for slaughter by use of gas, in which the animals are passed through a gas-filled anesthetization chamber for anesthetization.

There is a constant need to stun slaughter animals in an animal-friendly and cost-effective manner prior to slaughter.

It is the object of the invention to provide measures which enable an animal-friendly and cost-effective stunning of slaughter animals. In particular, it is the object of the present invention to provide measures which reduce the loss of the gases used for stunning.

This object is achieved by the features of the independent claims. Preferred further developments can be found in the subclaims.

According to the invention, a stunning facility for two-stage stunning of a slaughter animal by means of a pre-stunning gas and a final stunning gas is provided, comprising a stunning channel having an entrance opening and an exit opening for providing a gas atmosphere which stuns the slaughter animal, a conveying device passing through the stunning channel for conveying the slaughter animal through the stunning channel in a transport direction from the entrance opening to the exit opening, a pre-stunning gas supply for supplying the pre-stunning gas into the stunning channel, a final stunning gas supply for supplying the final stunning gas into the stunning channel, a gas discharge arranged in the transport direction between the pre-stunning gas supply and the final stunning gas supply for discharging the gas atmosphere from the stunning channel, and a recovery system for the pre-stunning gas and/or the final stunning gas connected to the gas discharge.

One aspect is to design the stunning channel not with a stationary gas atmosphere, but to provide a slightly moving gas atmosphere in the stunning channel by means of the pre-stunning gas supply, the final stunning gas supply and the gas discharge arranged between the pre-stunning gas supply and the final stunning gas supply, and to connect the gas discharge to the recovery system for the purpose of recovering the pre-stunning gas and/or the final stunning gas. Preferably, this is a recovery system for the pre-stunning gas, more preferably a recovery system for the pre-stunning gas and the final stunning gas. The recovery makes it possible to separate the pre-stunning gas and/or final stunning gas used in the stunning channel from the gas mixture discharged from the stunning channel. In this way, the loss of pre-stunning gas and/or final stunning gas, and preferably the loss of pre-stunning gas, is reduced and the stunning facility can be operated very cost-effectively. In addition, the slight gas movement caused by the pre-stunning gas supply, the final stunning gas supply and the gas discharge allows greater structural freedom of the stunning channel, so that it is possible to dispense with designing the stunning channel in such a way that the gas atmosphere provided by the pre-stunning gas and the gas atmosphere provided by the final stunning gas are positioned partially overlapping one above the other in the vertical direction. Accordingly, the present stunning facility makes it easier to find a suitable installation site for the stunning facility in a slaughterhouse. In addition, the manufacturing costs and assembly costs of the stunning facility are low.

The stunning channel preferably comprises a wall and thus provides a volume in which the gas atmosphere that stuns the slaughter animal can be held. In addition to the entrance opening and the exit opening, as well as the openings provided by the pre-stunning gas supply, the final stunning gas supply and the gas discharge, the stunning channel and/or the wall of the stunning channel preferably have no further openings. In addition, the wall of the stunning channel is preferably designed to be gas-tight. This further reduces the loss of the pre-stunning gas and/or final stunning gas. The openings of the stunning channel, i.e. the entrance opening and the exit opening, and in particular the openings of the pre-stunning gas supply, the final stunning gas supply and the gas discharge can be designed to be closable. Preferably, the openings of the pre-stunning gas supply, the final stunning gas supply and the gas discharge are provided with controllable valves. In this way, the slight gas movement present in the stunning channel can be controlled in a targeted manner and as required. The entrance opening and/or the exit opening can further preferably be provided with a flexible separating device, such as a strip curtain and/or an industrial curtain. This further reduces the loss of pre-stunning gas and/or final stunning gas.

In principle, the slaughter animal can be any slaughter animal. For example, it can be a mammal or poultry, such as (domestic) pigs, cattle, sheep, goats, horses, chickens, geese, turkeys, hares, rabbits, venison, birds, bison, reindeer, but also marsupials, such as kangaroos, and/or lizards, such as crocodiles or alligators. Preferably, the slaughter animal is a pig.

The conveying device is designed to convey one or more slaughter animals through the stunning channel from the entrance opening to the exit opening. The conveying device can be designed as a continuous conveyor or as a discontinuous conveyor or as a series of a discontinuous conveyor and a continuous conveyor. In particular, in the case of gregarious animal or pack animal it is reassuring for the slaughter animal if it is not introduced into the stunning channel individually. Preferably, the conveying device is designed to convey a plurality of slaughter animals. In the case of pigs as slaughter animals, the conveying device is preferably designed to convey 6 to 15 pigs.

According to a preferred further development of the invention, it is provided that the stunning facility is designed such that in a first section of the stunning channel a gas atmosphere can be provided which is essentially formed by the pre-stunning gas, and in a second section of the stunning channel, which is directly adjacent thereto in the transport direction, a gas atmosphere can be provided which is essentially formed by the final stunning gas, and that a gas atmosphere can be provided in the first section and/or in the second section, in which a gas movement for gas discharge is present. In other words, it is preferably provided that, during operation of the stunning facility, in a first section of the stunning channel a gas atmosphere is provided which is essentially formed by the pre-stunning gas, and in a second section of the stunning channel, which is directly adjacent thereto in the transport direction, a gas atmosphere is provided which is essentially formed by the final stunning gas, and that a gas movement of the gas atmosphere for gas discharge is present in the first section and/or in the second section. A gas atmosphere which is essentially formed by the pre-stunning gas is understood in the present case to be a gas atmosphere which is formed to more than 95% by volume by the pre-stunning gas and whose oxygen content is less than 1% by volume. Similarly, a gas atmosphere which is essentially formed by the final stunning gas is understood here to be a gas atmosphere which is formed to more than 95% by volume by the final stunning gas and whose oxygen content is less than 1% by volume. Preferably, moreover, at least partial gas movement of the gas atmosphere in the first section and in the second section for gas discharge is provided. The pre-stunning gas and the final stunning gas are preferably two chemically different gases or gas mixtures.

The two sections directly adjoining one another in the transport direction allow the slaughter animals to pass through the section of the stunning channel with the final stunning gas in a state pre-stunned by the pre-stunning gas. Because the slaughter animals continue to breathe in the stunned state, the pre-stunning gas inhaled by the slaughter animals in the first section is exhaled from the lungs of the slaughter animals in the second section by the breathing movement of the slaughter animals. The gas movement of the gas atmosphere to the gas discharge results in that the pre-stunning gases exhaled by the slaughter animals in the second section are also fed to the recovery system. In this way, the loss of pre-stunning gas is extremely low.

Due to the sections with the different gas atmospheres directly adjoining one another in the transport direction, wherein the first gas atmosphere in the transport direction is essentially formed by the pre-stunning gas and the gas atmosphere directly adjoining it is essentially formed by the final stunning gas, the stunning and slaughtering of slaughter animals can also be carried out in an animal-friendly and respectful manner. Pre-stunning in the pre-stunning section can be designed to make stunning as animal-friendly as possible, in particular by using helium and/or argon as the pre-stunning gas, in which the slaughter animal generally does not show any stress-inducing defensive reactions, but can fall asleep peacefully. In addition, with this type of pre-stunning gas, there is no risk that the meat quality is impaired due to stress reactions of the slaughter animal. In the second section, the final stunning section, a final stunning of the slaughter animal then takes place at a later time, in which the final stunning gas, for example nitrogen or CO₂, is used, which can be selected for the purpose of a sufficiently deep and sufficiently long stunning in order to kill the slaughter animal as stress-free and pain-free as possible for the subsequent slaughter and cutting. Any impairment of the meat quality due to stress effects on the slaughter animal shortly before killing and slaughtering can be avoided in this way. Due to the pre-stunning, it is possible to select a stunning agent for the final stunning gas that would otherwise be expected to cause defensive reactions or other stress reactions in the slaughter animal without pre-stunning. The final stunning gas, too, can be selected in such a way that there is no risk of impairment of the meat quality of the slaughter animal. By pre-stunning with a pre-stunning gas that essentially does not cause any defensive reactions, it is also possible to stun the slaughter animal almost painlessly and in an animal-friendly, species-appropriate and respectful manner and then kill it without fear that the stunning itself will kill the slaughter animal, for example due to extreme stress reactions. This even makes it possible to slaughter the slaughter animal in accordance with halal criteria according to more modern interpretations.

According to another preferred further development of the invention it is provided that the stunning facility is designed such that in a first region of the stunning channel a gas movement of the gas atmosphere in the transport direction can be provided and that in a second region of the stunning channel directly adjacent thereto in the transport direction, a gas movement of the gas atmosphere opposite to the transport direction can be provided. In other words, it is preferably provided that, during operation of the stunning facility, a gas movement of the gas atmosphere in the transport direction is present in a first region of the stunning channel and a gas movement of the gas atmosphere opposite to the transport direction is present in a second region of the stunning channel directly adjacent thereto in the transport direction. It is further preferably provided that the first region of the stunning channel, in which the gas movement of the gas atmosphere is present in the transport direction, is the pre-stunning section, and thus a gas atmosphere is also present in the first region, which is essentially formed by the pre-stunning gas. Further preferably, the first region and correspondingly the pre-stunning section extends from the pre-stunning gas supply to the gas discharge. The final stunning section of the stunning channel preferably directly adjoins the first region and/or pre-stunning section. Preferably, in the final stunning section a gas atmosphere is present, which is essentially formed by the final stunning gas. It is also preferably provided that at least in a part of the final stunning section there is a gas movement of the gas atmosphere opposite the transport direction. In other words, it is thus preferably provided that the second region with the gas movement opposite to the transport direction extends over at least a part of the final stunning section.

In connection with the stunning gases, according to a preferred further development, it is provided that the pre-stunning gas has a lower density than air and/or that the pre-stunning gas is helium and/or that the final stunning gas is nitrogen and/or carbon dioxide. Helium has the advantage over argon as a pre-stunning gas that the meat quality is improved. Preferably, the final stunning gas is nitrogen. Nitrogen has a lower density difference to air compared to carbon dioxide, so that compared to carbon dioxide, if nitrogen potentially escapes from the stunning channel, the risk is reduced that the final stunning gas accumulates in layers close to the ground and thus impairs the work safety of persons working with the stunning system is reduced.

In connection with the recovery system, according to a preferred further development, it is provided that the recovery system is a helium recovery system and/or is designed to perform gas separation by means of a membrane. Helium, as the smallest and lightest noble gas, is increasingly present in a segregated form in the earth's atmosphere above an altitude of 100 km and escapes into space at altitudes>400 km. As the replenishment of helium on earth from natural gas and in small quantities from crude oil is limited and is also subject to strong fluctuations, which are reflected in high prices, helium recovery makes it possible to keep the operating costs of the stunning facility low and stable. In principle, there are several ways of recovering helium. For example, the helium recovery system can be designed as a cryogenic system that separates the helium from other gases by means of gas liquefaction at low temperatures. However, it is preferable that the recovery system, and in particular the helium recovery system, is designed to perform gas separation by means of a membrane. Helium recovery by means of membranes has the advantage that no cryogenic conditions need to be present and therefore no costs for cooling are incurred. Preferably, the recovery system is a two-stage membrane process, which further preferably can be combined with a helium pressure swing adsorption system.

In principle, it is possible that the pre-stunning gas supply and/or the final stunning gas supply are each connected to pre-stunning containers for the pre-stunning gas or the final stunning gas. Accordingly, the pre-stunning gas supply can supply the pre-stunning gas from the pre-stunning container to the stunning channel and/or the final stunning gas supply can supply the final stunning gas from the pre-stunning container to the stunning channel. The pre-stunning container and/or the final stunning container can be refilled continuously or discontinuously. In this connection, according to another further development of the invention, it is provided that the recovery system is connected to the pre-stunning gas supply and/or the final stunning gas supply. In other words, the pre-stunning gas recovered and/or recycled by the recovery system is preferably used directly for the pre-stunning gas supply, thus enabling continuous refilling. Similarly, it may be provided that the final stunning gas recovered and/or recycled by the recovery system is likewise used for the final stunning gas supply. In this way, an operationally low-maintenance cycle process can be provided, since there is no need to manually replace the pre-stunning containers and/or the final-stunning containers.

Furthermore, according to a preferred further development of the invention, it is provided that the stunning channel in the region of gas discharge is configured with a separating device for reducing the mixing of a gas atmosphere, which is essentially formed by the pre-stunning gas, with a gas atmosphere, which is essentially formed by the final stunning gas. The separating device is preferably a strip curtain and/or an industrial curtain. This is preferably arranged in the transition from the pre-stunning section to the final stunning section. In this context, it may preferably be provided that the gas discharge for reducing the gas mixing discharges gas in the transport direction upstream of the separating device and in the transport direction downstream of the separating device in order to reduce gas mixing. Furthermore, it may be provided that the gas discharge discharges gas in the transport direction upstream of the separation device and in the transport direction downstream of the separation device, and that the two gas flows are treated differently in the recovery system due to the different concentrations of pre-stunning gas and final stunning gas.

According to a preferred further development of the invention and in particular in connection with the gas used as pre-stunning gas, which has a lower density than air, it is provided that the stunning channel between the entrance opening and the exit opening comprises a region which is located at a higher level than the entrance opening and/or than the exit opening of the stunning channel. Preferably, the pre-stunning section is located in the region located at a higher level. Further preferably, the entrance opening and the exit opening are disposed at approximately the same height and the region located at a higher level is higher, preferably approximately four meters higher than the entrance opening and/or than the exit opening. Further preferably, the stunning channel is essentially configured in the shape of an inverted “U”. The region located at a higher level has the advantage that the pre-stunning gas used in the pre-stunning section, which preferably has a lower density than air, already accumulates in the region located at the higher region due to the lower density. This facilitates the provision of the pre-stunning atmosphere in the pre-stunning section.

In this connection, according to a preferred further development of the invention, it is provided that the stunning channel comprises a feed section adjacent to the entrance opening which extends upwards in the transport direction. Preferably, the feed section extends vertically upwards. In other words, the feed section preferably connects the entrance opening with the pre-stunning section which is preferably located at a higher level. It is further preferably provided that the feed section is disposed directly upstream of the pre-stunning section in the transport direction. In this context, it is further preferably provided that there is no gas atmosphere stunning for the slaughter animal in the feed section in the region of the entrance opening. This facilitates the introduction of the slaughter animal or the plurality of slaughter animals into the stunning channel, because the slaughter animals can walk into the entrance opening of the stunning channel autonomously in this way.

Furthermore, in this connection, a dispensing device for generating a nitrogen curtain can be provided directly at the entrance opening of the stunning channel. The dispensing device can, for example, comprise a nitrogen cartridge or be connected to another nitrogen source. When the slaughter animal is moved through the nitrogen curtain generated by the dispensing device, the slaughter animal is exposed to an increased concentration of nitrogen in the breathing air, at least for a short time, which can lead to a lack of oxygen supply (hypoxia) in the slaughter animal. This hypoxia can lead to slight loss of consciousness and a calming drowsiness of the slaughter animal after just a few seconds. Preferably, the non-stunning gas atmosphere in the region of the entrance opening already has a reduced oxygen concentration compared to the ambient air in order to already achieve a calming of the slaughter animal.

In connection with the conveying device, according to another preferred further development it is provided that the conveying device passing through the feed section of the stunning channel is designed as a vertically adjustable transport belt. Preferably, this is a transport belt that is suspended on ropes or chains and is thus vertically adjustable. The vertically adjustable transport belt is preferably designed in such a way that it also enables a conveying movement along the horizontal. Particularly in the case of slaughter animals in herd and/or pack form, it is reassuring for the slaughter animal if it is not introduced into the stunning channel individually. In this context, it is preferably provided that the vertically adjustable transport belt accommodates a plurality of slaughter animals, in the case of pigs around 6 to 15 pigs.

Preferably, the feed section connects the entrance opening with the pre-stunning section which is preferably located at a higher level. Accordingly, the vertically adjustable transport belt preferably conveys the slaughter animal from the gas atmosphere, which is not stunning for the slaughter animal in the region of the entrance opening, to the pre-stunning atmosphere preferably located at a higher level in the pre-stunning section of the stunning channel. In order to avoid an air pumping effect and thus a mixing of the gas atmosphere that is not stunning for the slaughter animal with the pre-stunning atmosphere that is stunning for the slaughter animal when the conveying device is adjusted vertically in the feed section, the conveying device used in the feed section and preferably the vertically adjustable transport belt is designed to be gas-permeable.

Preferably, it can be provided that the conveying device used in the feed section, preferably the vertically adjustable transport belt, comprises a perforated bottom. In this way, the gas can flow through the perforated bottom when the conveying device is adjusted vertically, in particular essentially without any significant flow resistance. The perforation provided in the bottom has openings that are configured so small that the slaughter animal can walk over the perforated bottom autonomously. At the same time, the sum of the opening cross-sections of the openings can be large enough to ensure that the back pressure, if present, is negligible during vertical adjustment.

Furthermore, it is preferably provided in this context that the conveying device passing through the pre-stunning section and the final stunning section is designed as a conveyor belt. This enables easy conveyance of the pre-stunned and finally stunned slaughter animals through the stunning channel. In other words, the conveying device used in the feed section is preferably designed as a vertically adjustable transport belt and the conveying device passing through the pre-stunning section and the final stunning section is designed as a conveyor belt. In this way, after the slaughter animal has been moved through the feed section by the vertically adjustable transport belt, the slaughter animal can be conveyed through the stunning channel by the conveying movement of the transport belt and the adjoining conveyor belt.

Preferably, the conveying device is designed to convey the pre-stunned and/or finally stunned slaughter animal. After pre-stunning, the stunned slaughter animal can come to lie on the conveying device and can then be conveyed through the stunning channel by the conveying device, which is driven in particular by a motor. Preferably, the conveying device can also be designed to convey the finally stunned slaughter animal out of the exit opening of the stunning channel.

In addition, according to another preferred further development of the invention, it may be provided that a conveying speed of the conveying device is adapted to the length of the stunning channel and to the type of slaughter animal. In this way, it is easily ensured that the slaughter animal is exposed to the gas atmosphere in the stunning channel for such a long time that a sufficiently deep stunning is present for the subsequent slaughter and thus a painless slaughter is possible.

It is preferably provided that the stunning channel comprises a region between the entrance opening and the exit opening that is located at a higher level than the entrance opening and/or than the exit opening of the stunning channel. In addition, it is preferably provided that the stunning channel comprises a feed section adjacent to the entrance opening, which extends upwards in the transport direction. In this connection, according to a further preferred embodiment of the invention, it is provided that the stunning channel extends horizontally between the pre-stunning gas supply and the gas discharge and/or that the stunning channel first extends horizontally between the gas discharge and the final stunning gas supply in the transport direction and then inclines downwards. It is thus preferably provided that the stunning channel, after extending vertically upwards in the feed section, extends horizontally in the pre-stunning section, i.e. between the pre-stunning gas supply and the gas discharge. In other words, the stunning channel preferably has a change of direction at the transition from the feed section to the pre-stunning section, i.e. preferably at the pre-stunning gas supply. In addition, it is preferably provided that the stunning channel initially extends horizontally in the transport direction and then extends downwards inclined in the final stunning section, i.e. between the gas discharge and the final stunning gas supply. Preferably, the inclination is no more than 30 degrees. The horizontal and then only slightly downwardly inclined course of the stunning channel makes it easy to ensure that the stunned animals arrive at the exit opening of the stunning channel undamaged from a transportation point of view.

With regard to an advantageous distribution of the pre-stunning gas and the final stunning gas in the stunning channel and, in particular, of the pre-stunning gas in the pre-stunning section and of the final stunning gas in the final stunning section, according to a preferred further development of the invention it is provided that the pre-stunning gas supply is located at a higher level than the final stunning gas supply and/or that the pre-stunning gas supply is located at a higher level than the gas discharge and/or that the gas discharge is located at the same height or at a higher level than the final stunning gas supply. It is particularly preferably provided that the pre-stunning gas supply is provided in a ceiling of the region of the stunning channel located at a higher level, preferably in the transport direction at the beginning of the pre-stunning section which is located at a higher level and extends horizontally. Furthermore, the gas discharge is preferably provided in a bottom of the stunning channel, preferably in the transition from the pre-stunning section to the final stunning section. In addition, the final stunning gas supply is preferably provided in the ceiling of the downwardly inclined region of the final stunning section, such that the final stunning gas supply is disposed at the same height or lower than the gas discharge.

According to another preferred further development, it is provided that the stunning system comprises a further gas outlet arranged downstream of the final stunning gas supply in the transport direction for discharging the gas atmosphere from the stunning channel. This further gas discharge is preferably provided approximately one meter upstream of the exit opening of the stunning channel. Further preferably, the further gas discharge is located at a lower level than the first gas discharge and at a lower level than the final stunning gas supply. Preferably, the further gas outlet ensures that the final stunning atmosphere is provided as far as possible up to the exit opening of the stunning channel or as close as possible to the exit opening of the stunning channel, so that a sufficiently long and deep final stunning of the slaughter animal is ensured. In addition, the further gas discharge ensures that as little final stunning gas as possible escapes from the stunning channel. This increases work safety at the stunning channel and also reduces a loss of the final stunning gas.

In connection with the work safety, according to a preferred further development of the invention, it is also provided that the pre-stunning gas supply, the final stunning gas supply and the gas discharge are matched to one another in such a way that a pressure within the stunning channel at the entrance opening and/or at the exit opening is lower than an ambient pressure. It is further preferably provided that the pre-stunning gas supply, the final stunning gas supply, the gas discharge and the further gas discharge are matched to one another in such a way that a pressure within the stunning channel at the entrance opening and/or at the exit opening is lower than an ambient pressure. In addition, it is preferably provided that the pressure within the stunning channel at the entrance opening and at the exit opening is lower than the ambient pressure. In this way, a small amount of ambient air is respectively drawn into the stunning channel. Accordingly, it is ensured that no pre-stunning gas and/or final stunning gas escapes from the stunning channel. This increases work safety and moreover reduces loss of the pre-stunning gas and/or the final stunning gas, particularly in connection with the gas discharge of the recovery system.

In order to enable monitoring of the gas atmosphere provided in the stunning channel, according to a preferred further development of the invention, it is provided that the stunning facility comprises a plurality of oxygen sensors for detecting an oxygen content of the gas atmosphere provided by the stunning channel. Further preferably, it may be provided that the stunning facility comprises a plurality of pre-stunning gas sensors for detecting a content of pre-stunning gas in the gas atmosphere provided by the stunning channel and/or a plurality of final stunning gas sensors for detecting a content of final stunning gas in the gas atmosphere provided by the stunning channel.

Preferably, it is provided that the sensors, i.e. the oxygen sensors, the pre-stunning gas sensors and/or the final stunning gas sensors are provided spaced apart from each other along the transport direction in the stunning channel. It is further preferably provided that the stunning channel comprises a sensor approximately every 20 height centimeters in the feed section. In addition, it is preferably provided that the stunning channel comprises a sensor in the pre-stunning section and/or in the final stunning section approximately every meter along the transport direction. This makes it easy to continuously monitor the gas atmosphere provided in the stunning channel. This makes it possible to check whether the concentration of the pre-stunning gas and/or final stunning gas is sufficiently high and/or the concentration of oxygen is sufficiently low for stunning the slaughter animal. The concentrations of the pre-stunning gas, the final stunning gas and/or the oxygen in the stunning channel can be recorded continuously, for example for documentation purposes.

In this context, it may preferably be provided that the sensors are communicatively connected to a control unit for the pre-stunning gas supply, the final stunning gas supply, the gas discharge and/or the further gas discharge.

Further preferably, it can be provided that, in particular automatically, the pre-stunning gas supply, the final stunning gas supply, the gas discharge and/or the further gas discharge are controlled in such a way that an oxygen content in the pre-stunning section and/or in the final stunning section is below 1% by volume. Alternatively or additionally, it may also preferably be provided that, in particular automatically, the pre-stunning gas supply, the final stunning gas supply, the gas discharge and/or the further gas discharge are controlled in such a way that the concentration of pre-stunning gas is above 95% by volume in the pre-stunning section and/or that the concentration of final stunning gas is above 95% by volume in the final stunning section.

For the purpose of separating and feeding the slaughter animals pre-stunned and finally stunned through the stunning channel for slaughtering, according to another preferred further development of the invention, it is provided that the stunning facility comprises a conveyor belt arranged in the transport direction directly downstream of the exit opening of the stunning channel for separating the slaughter animals guided through the stunning channel. Preferably, this is a conveyor belt whose transport direction is transverse to the transport direction of the conveying device passing through the stunning channel. In this way, the separation of the slaughter animals is particularly simple.

A further aspect of the invention relates to a method for stunning a slaughter animal by use of the stunning facility described above, comprising the steps of:
providing one or more slaughter animals on a conveying device passing through a stunning channel of the stunning facility, and
conveying the one or more slaughter animals provided on the conveying device through the stunning channel by means of the conveying device in such a way that the one or more slaughter animals are guided through a region of the stunning channel in a pre-stunned state caused due to a pre-stunning gas, in which a gas atmosphere is essentially formed by a final stunning gas different from the pre-stunning gas and there is a gas movement of the gas atmosphere to a gas discharge connected to a recovery system.

On the one hand, the process enables animals to be stunned and slaughtered in an animal-friendly and respectful manner. On the other hand, it is possible for the slaughter animals to pass in a state pre-stunned by a pre-stunning gas through the region of the stunning channel, in which the gas atmosphere is essentially formed by the final stunning gas and the gas movement of the gas atmosphere to the gas discharge connected to the recovery system is present. Because the slaughter animals continue to breathe in the stunned state, the pre-stunning gas previously inhaled by the slaughter animals is exhaled from the lungs of the slaughter animals in this region by the breathing movement of the slaughter animals. The gas movement of the gas atmosphere to the gas discharge results in that the pre-stunning gases exhaled by the slaughter animals in this region are also fed to the recovery system. In this way, the loss of pre-stunning gas is extremely low in the proposed method.

Further technical effects and associated advantages of the present method are obvious to the skilled person from the description of the stunning facility and from the following description of the drawings.

In the following, the invention is explained by way of example with reference to the attached drawings based on preferred exemplary embodiments, wherein the features shown below can represent an aspect of the invention both individually and in combination. In the drawings:

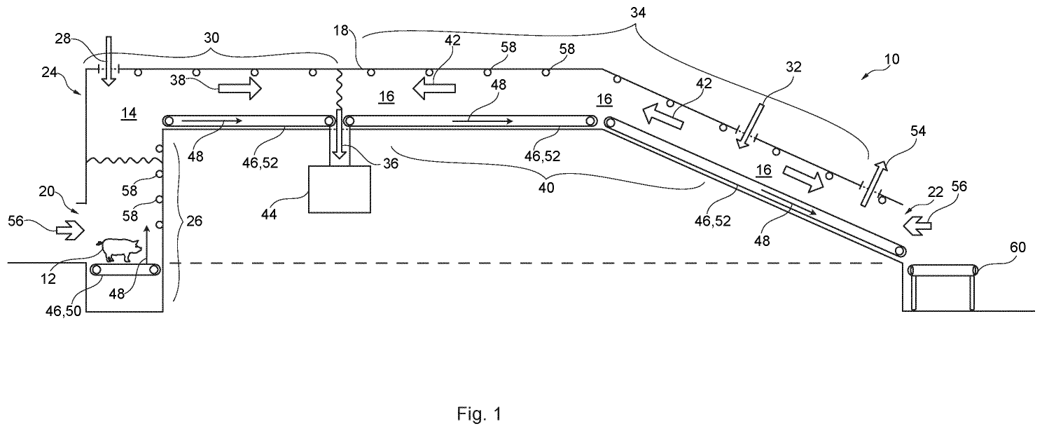

FIG. 1 is a schematic sectional view of a stunning facility 1 during driving in slaughter animals according to a preferred embodiment of the invention; and

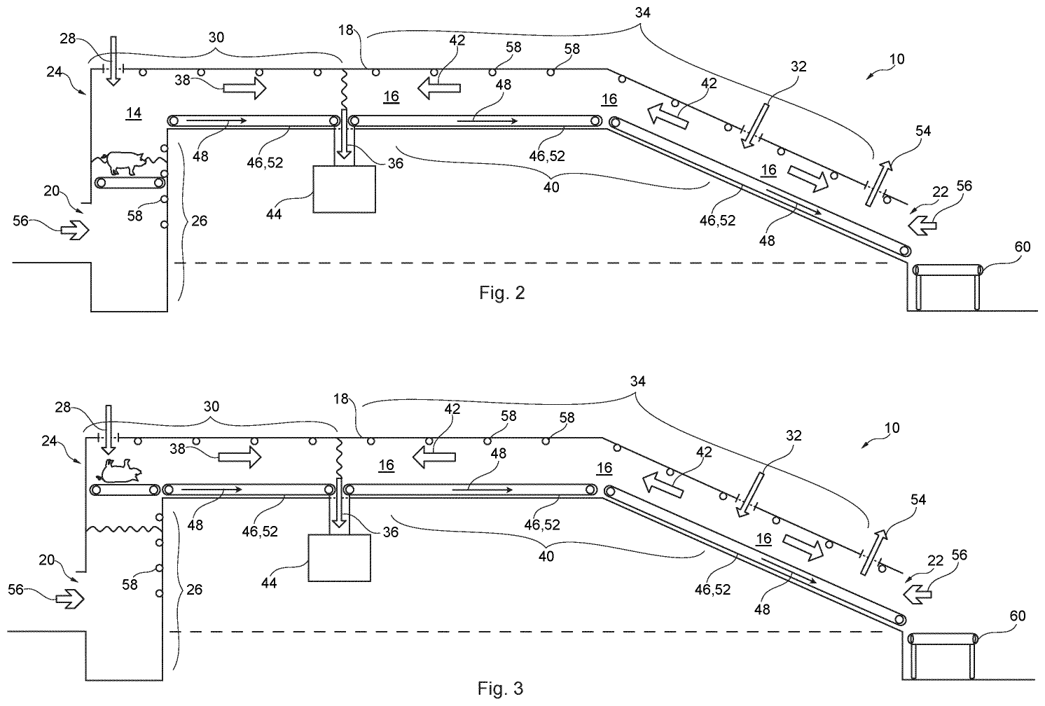

FIGS. 2 to 7 show a schematic sectional view of the stunning facility of FIG. 1 during transportation of the slaughter animals through the stunning facility.

The stunning facility 10 shown in FIG. 1 can be used for stunning a slaughter animal 12, in the present embodiment pigs, before the slaughter animal 12 is killed and slaughtered. The stunning of the slaughter animal 12 is a two-stage stunning by means of a pre-stunning gas 14, in the present embodiment helium, and a final stunning gas 16, in the present embodiment nitrogen. With reference to FIGS. 1 to 7, the stunning facility 10 and a method for stunning the slaughter animals 12 by use of the stunning facility 10 are explained below.

The stunning facility 10 comprises a stunning channel 18 comprising an entrance opening 20 and an exit opening 22. The slaughter animals 12 are fed through the entrance opening 20 to the stunning channel 18 (see FIG. 1), which provides the gas atmospheres with the pre-stunning gas 14 and the final stunning gas 16 for stunning the slaughter animal 12. In the present exemplary embodiment, the stunning channel 18 essentially has the shape of an inverted “U”, wherein the stunning channel 18 comprises a region 24 between the entrance opening 20 and the exit opening 22, which region is located at a higher level than the entrance opening 20 and the exit opening 22, which are located at the same height. In order to connect the entrance opening 20 to the region 24 located at a higher level, the stunning channel 18 in the present exemplary embodiment comprises a feed section 26 leading vertically upwards.

In the transition from the feed section 26 to the region 24 located at a higher level, a pre-stunning gas supply 28 for supplying the pre-stunning gas 14 into the stunning channel 18 is disposed in a ceiling of the stunning channel 18. In this way, at least in a horizontally designed section 30 of the stunning channel 18, a gas atmosphere is provided which is formed to at least 95% by volume from the pre-stunning gas helium 14 and contains less than 1% by volume oxygen. In this section 30—the pre-stunning section 30—the slaughter animals 12 are pre-stunned (see in particular FIGS. 3, 4 and 6).

In addition, the stunning channel 18 comprises a final stunning gas supply 32 for supplying the final stunning gas 16, in this case nitrogen, into the stunning channel 18. In this way, a gas atmosphere is provided in a further section 34 of the stunning channel 18, which is formed to at least 95% by volume from the final stunning gas nitrogen 16 and contains less than 1% by volume oxygen. This further section 34-the final stunning section 34—directly adjoins the pre-stunning section 30. In the final stunning section 34, the slaughter animals 12 are finally stunned so that a sufficiently deep stunning is provided for the subsequent slaughtering (see in particular FIGS. 5 to 7). In the present case, the final stunning section 34 initially extends horizontally subsequent to the pre-stunning section 30 and then has an inclination of 30 degrees downwards in the direction of the exit opening 22.

Between the pre-stunning gas supply 28 and the final stunning gas supply 32, a gas discharge 36 for discharging the gas atmosphere from the stunning channel 18 is provided in the bottom of the stunning channel 18. By means of the pre-stunning gas supply 28, the final stunning gas supply 32 and the gas discharge 36 a gas movement 38 of the pre-stunning gas atmosphere 14 to the gas discharge 36 is achieved in the pre-stunning section 30 and a gas movement 42 of the final stunning gas atmosphere 16 to the gas discharge 36 is achieved in a region 40 of the final stunning section 34. The gas discharge 36 is connected to a recovery system 44 for the pre-stunning gas.

In the present case, this is a helium recovery system 44, which separates the helium from the gas mixture discharged from the gas discharge 36 by means of a membrane.

In order to guide the slaughter animals 12 through the stunning channel 18, the stunning facility 10 comprises a conveying device 46 leading through the stunning channel 12 for conveying the slaughter animals 12 through the stunning channel 18 in a transport direction 48 from the entrance opening 20 to the exit opening 22. In the feed section 26, the conveying device 46 is designed as a vertically adjustable transport belt 50. The transport belt 50 suspended at ropes (ropes not shown in the figures) allows a transportation in a vertical direction due to the ropes (see in particular FIGS. 2 and 5) and a conveyance in a horizontal direction by conveying the transport belt 50. In the present exemplary embodiment, the transport belt 50, which is designed to be gas-permeable, is also configured to accommodate ten pigs 12. For the sake of clarity, however, only one pig 12 is shown in the figures.

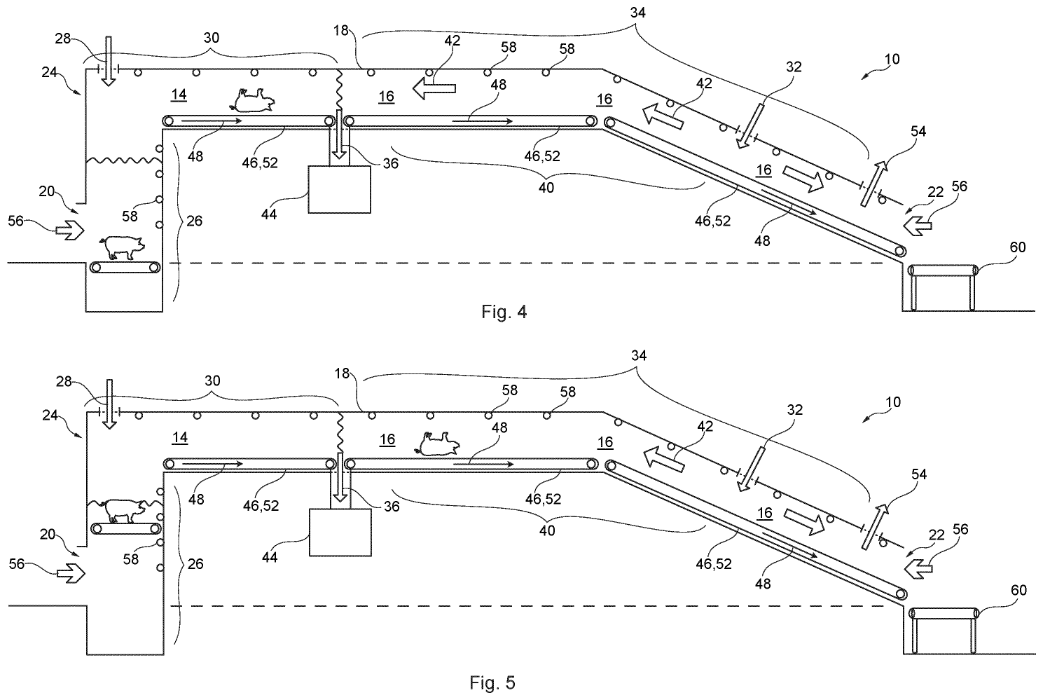

In the pre-stunning section 30 and in the final stunning section 34, the transport direction 48 is designed as a conveyor belt 52. In this way, after the slaughter animals 12 have been moved from the vertically adjustable transport belt 50 through the feed section 26 (see FIGS. 2 and 3), the slaughter animal can be transported through the pre-stunning section 30 (see FIG. 4) and the final stunning section 34 (see FIGS. 5 to 7) of the stunning channel 18 by the conveying movement of the transport belt 50 and the adjoining conveyor belt 52.

In addition, the stunning channel 18 has a further gas discharge 54 downstream of the final stunning gas supply 32 in the transport direction 48. The further gas discharge 54 is located 1 meter upstream of the exit opening 22 in the ceiling of the stunning channel 18. The pre-stunning gas supply 28, the final stunning gas supply 32, the gas discharge 36 and the further gas discharge 54 are matched to one another in such a way that a pressure within the stunning channel 18 at the entrance opening 20 and at the exit opening 22 is lower than an ambient pressure. As a result, a small amount of ambient air 56 is drawn in from the stunning channel 18 at the entrance opening 20 and at the exit opening 22, respectively.

In order to monitor and control the gas atmosphere within the stunning channel 18, the stunning facility 10 comprises a plurality of oxygen sensors 58. These are mounted every 20 height centimeters in the feed section 26 and every meter in the pre-stunning section 30 and in the final stunning section 34 along the transport direction 48. The oxygen sensors 58 are connected communicatively to a control unit for the pre-stunning gas supply 28, the final stunning gas supply 32, the gas discharge 36 and the further gas discharge 54, so that a fully automatic control of the gas atmosphere in the stunning channel 18 takes place.

In the method for stunning the slaughter animals 12 with the stunning facility 10, the slaughter animals 12 are provided in a first step on the conveying device 46 passing through the stunning channel 18 (see FIGS. 1 and 4). At this point, the slaughter animals 12 are in a non-stunning gas atmosphere, so that the slaughter animals 12 enter the stunning channel 18 and the conveying device 46, namely the vertically adjustable transport belt 50, autonomously. The bottom of the vertically adjustable transport belt 50, which is designed to be gas-permeable, is such that the slaughter animals 12 can walk thereon autonomously.

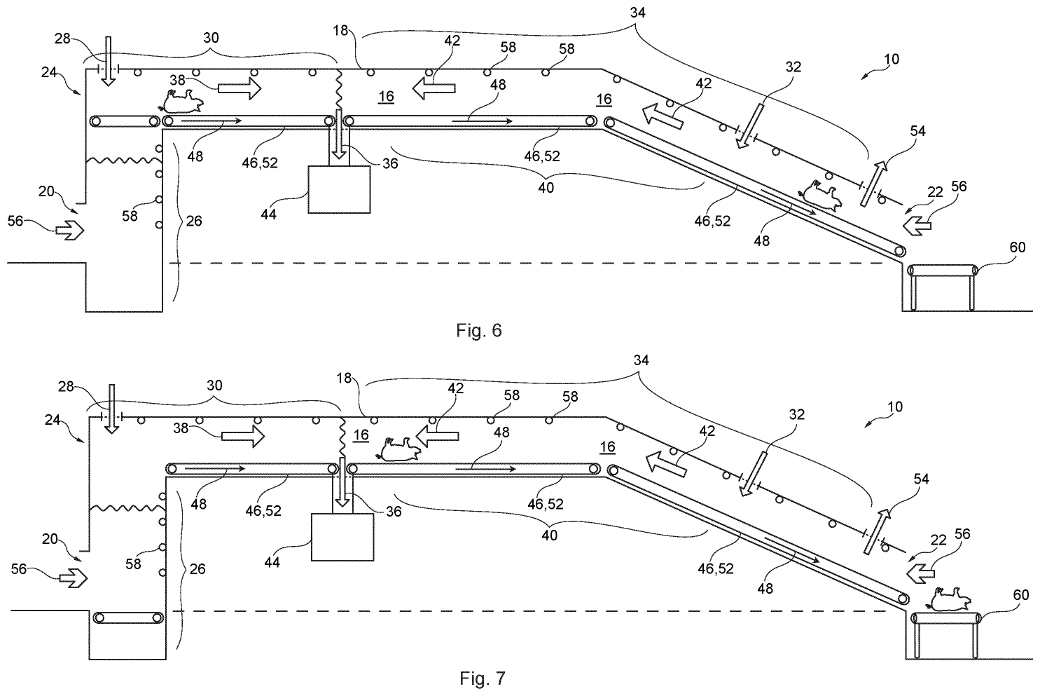

In a further step, the vertically adjustable transport belt 50 moves with the slaughter animals 12 up the feed section 26 of the stunning channel 18 to the pre-stunning section 30 (see FIGS. 2 and 5). At the top of the pre-stunning section 30, the gas atmosphere is essentially formed by the pre-stunning gas 14 in a controlled and monitored way by use of the pre-stunning gas supply 28 and the oxygen sensors 58. Once they have arrived here, the slaughter animals 12 are pre-stunned (see FIGS. 3 and 6).

The pre-stunned slaughter animals 12 are then conveyed by the conveying device 46 through the pre-stunning section 30 in the transport direction 48 towards the final stunning section 34 (FIGS. 4 and 6). The slaughter animals 12 are thus conveyed in the pre-stunned state through the final stunning section 34, where the final stunning takes place (see FIG. 4). As already mentioned, the final stunning section 34 comprises the region 40 in which the gas atmosphere has a gas movement 42 towards the gas discharge 36 and thus against the transport direction 48 of the slaughter animals. In this region 40, the slaughter animals 12 exhale the pre-stunning gas 14 inhaled in the pre-stunning section 30 and the exhaled pre-stunning gas 14 is guided with the gas movement 42 to the gas discharge 36 and to the recovery system 44 for pre-stunning gas 14. During transportation of the slaughter animals 12 through the pre-stunning section 30 in the transport direction 48 towards the final stunning section 34 (FIG. 4 or 6), as soon as the vertically adjustable transport belt 50 is no longer occupied by the slaughter animals 12, it can move downwards in the feed section 26 towards the entrance opening 20 in order to be ready for further slaughter animals 12.

In a further step, the finally stunned slaughter animals 12 (see FIGS. 6 and 7) are transported by the conveying device 46 out of the exit opening 22 of the stunning channel 18 onto a transverse belt 60 arranged transversely to the transport direction 48, where they are separated and fed to the subsequent killing and slaughtering.

### List of Reference Symbols

10 stunning facility
12 slaughter animal, pig
14 pre-stunning gas, helium
16 final stunning gas, nitrogen
18 stunning channel
20 entrance opening
22 exit opening
24 region located at a higher level of the stunning channel
26 feed section
28 pre-stunning gas supply
30 pre-stunning section
32 final stunning gas supply
34 final stunning section
36 gas discharge
38 gas movement in transport direction
40 region with gas movement opposite the transport direction
42 gas movement opposite the transport direction
44 recovery system for pre-stunning gas, helium recovery system
46 conveying device
48 transport direction
50 vertically adjustable transport belt
52 conveyor belt
54 further gas discharge
56 ambient air drawn in
58 oxygen sensor
60 transverse belt

1. A stunning facility (10) for two-stage stunning a slaughter animal (12) by means of a pre-stunning gas (14) and a final stunning gas (16), comprising:
a stunning channel (18) comprising an entrance opening (20) and an exit opening (22) for providing a stunning gas atmosphere for the slaughter ani-mal (12);
a conveying device (46) passing through the stunning channel (18) for conveying the slaughter animal (12) through the stunning channel (18) in a transport direction (48) from the entrance opening (20) to the exit opening (22);
a pre-stunning gas supply (28) for supplying the pre-stunning gas (14) into the stunning channel (18);
a final stunning gas supply (32) for supplying the final stunning gas (16) into the stunning channel (18);
a gas outlet (36) arranged in the transport direction (48) between the pre-stunning gas supply (28) and the final stunning gas supply (32) for dis-charging the gas atmosphere from the stunning channel (18); and
a recovery system (44) for the pre-stunning gas (14) and/or the final stunning gas (16) connected to the gas discharge (36).

2. The stunning facility (10) according to claim 1, wherein the stunning facility (10) is designed such that a gas atmosphere can be provided in a first section (30) of the stunning channel (18), which gas atmosphere is essentially formed by the pre-stunning gas (14), and a gas atmosphere can be provided in a second section (34) of the stunning channel (18) which is directly adjacent to the first section in the transport direction (48), which gas atmosphere is essentially formed by the final stunning gas (16), and such that a gas atmosphere can be provided in the first section (30) and/or in the second section (34), in which a gas movement (38, 42) to the gas discharge (36) is present.

3. The stunning facility (10) according to claim 1, wherein the stunning facility (10) is designed in such a way that a gas movement (38) of the gas atmosphere in the transport direction (48) can be provided in a first region (30) of the stunning channel (18) and that a gas movement (42) of the gas atmosphere opposite to the transport direction (48) can be provided in a second region (40) of the stunning channel directly adjoining the first region in the transport direction (48).

4. The stunning facility (10) according to claim 1, wherein the pre-stunning gas (14) has a lower density than air and/or wherein the pre-stunning gas (14) is helium and/or wherein the final stunning gas (16) is nitrogen and/or carbon dioxide.

5. The stunning facility (10) according to claim 1, wherein the recovery system (44) is a helium recovery system and/or is designed to perform gas separation by means of a membrane.

6. The stunning facility (10) according to claim 1, wherein the recovery system (44) is connected to the pre-stunning gas supply (28) and/or the final stunning gas supply (32).

7. The stunning facility (10) according to claim 1, wherein the stunning channel (18) in the region of the gas discharge (36) is designed with a separating device for reducing a mixing of a gas atmosphere which is essentially formed by the pre-stunning gas (14) with a gas atmosphere which is essentially formed by the final stunning gas (16).

8. The stunning facility (10) according to claim 1, wherein the pre-stunning gas supply (28) is located at a higher level than the final stunning gas supply (32) and/or wherein the pre-stunning gas supply (28) is located at a higher level than the gas discharge (36) and/or wherein the gas discharge (36) is located at the same height or at a higher level than the final stunning gas supply (32).

9. The stunning facility (10) according to claim 1, wherein the pre-stunning gas supply (28), the final stunning gas supply (32) and the gas discharge (36) are matched to one another in such a way that a pressure within the stunning channel (18) at the entrance opening (20) and/or at the exit opening (22) is lower than an ambient pressure.

10. A method for stunning a slaughter animal (12), with the use of a stunning facility (10) according to any one of the preceding claims, comprising the steps of:
providing one or more slaughter animals (12) on a conveying device (46) passing through a stunning channel (18) of the stunning facility (10); and
conveying the one or more slaughter animals (12) provided on the conveying device (46) through the stunning channel (12) by means of the conveying device (46) in such a way that the one or more slaughter animals (12) are guided in a pre-stunned state caused by a pre-stunning gas (12) through a region (40) of the stunning channel (18), in which a gas atmosphere is essentially formed by a final stunning gas (16) different from the pre-stunning gas (14) and there is a gas movement (42) of the gas atmosphere to a gas discharge (36) connected to a recovery system (44).
